(19) United States
(12) Patent Application Publication
(10) Pub. No.: US 2026/0061927 A1
(43) Pub. Date: Mar. 5, 2026

(54) CAMPER TRAILER OR CARAVAN

(71) Applicant: Patriot Campers Holdings Pty Ltd, Molendinar (AU)

(72) Inventors: Harrison Bell, Molendinar (AU); Justin Montesalvo, Meadowbrook (AU)

(21) Appl. No.: 19/290,685

(22) Filed: Aug. 5, 2025

(30) Foreign Application Priority Data
Sep. 4, 2024 (AU) 2024902776

(51) Int. Cl. B60P 3/36; B60R 15/02; B60R 15/04

(52) U.S. Cl. CPC B60P 3/36; B60R 15/02; B60R 15/04

(57) ABSTRACT

Provided is a towable accommodation to be towed by an automobile. The towable accommodation includes a shower, a toilet, and a cover for covering the toilet when using the shower. The shower and toilet may be located in close proximity, and the cover can be used to keep the toilet dry from water from the shower. The cover may also cover a floor of the shower when using the toilet to keep the user's feet dry.

### TECHNICAL FIELD

The present invention generally relates to a camper trailer or a caravan.

### BACKGROUND

The reference to any prior art in this specification is not, and should not be taken as an acknowledgement or any form of suggestion that the prior art forms part of the common general knowledge.

Camper trailers and caravans are both towable accommodation to be hooked up to an automobile and towed to a campsite. The automobile is the prime mover, whereas caravans and camper trailers are non-motorised and passively pulled behind the automobile.

Smaller than a caravan, a camper trailer generally contains a tent that folds out of the trailer, where other living equipment is packed. Its appeal comes from it being light and compact.

Camper trailers are often not provided with amenities such as showers and toilets, and so the user must wash and go to the toilet in the bush. The preferred embodiment provides an improved camper trailer.

### SUMMARY OF THE INVENTION

According to one aspect of the present invention, there is provided towable accommodation to be towed by an automobile, the towable accommodation including:
a shower;
a toilet; and
a cover for covering the toilet when using the shower.

Advantageously, the shower and toilet may be located in close proximity, and the cover may be used to keep the toilet dry from water from the shower. The cover may also cover a floor of the shower when using the toilet to keep the user's feet dry.

The cover may cover a drain of the shower in the floor. The cover may be hinged or able to pivot. The cover may be bent. The cover may be rigid. The cover may be molded. The cover may be formed from sheet metal or polymeric material.

The cover may form a complementary fit with a floor and wall of the shower.

The cover may include a roof panel and a front wall panel of a toilet receptacle. The toilet receptacle may include a body defining a lip. The toilet receptacle may include a seal mounted to the lip. In one embodiment, the cover may further include an interconnection panel for interconnecting the roof panel and front wall panel. The roof and front wall panels may be perpendicular. The interconnection panel may extend obliquely to the roof and the front wall panels. The interconnection panel may extend parallel to a angled mudguard section of the accommodation. The cover may include a handle.

The towable accommodation may include an enclosure for enclosing the toilet. The enclosure may contain water from the shower. The enclosure may include walls extending only partially up to a ceiling. A head of the shower may be attached to a ceiling. The enclosure may include a door. The door may be a sliding door or a hinged door. The enclosure may be fitted with a (mixer) tap for controlling the shower.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of a hybrid camper trailer in accordance with an embodiment of the present invention;

FIG. 2A is an upper perspective view showing a sanitary module of the camper trailer of FIG. 1 configured in shower mode;

FIG. 2B is an upper perspective view showing a sanitary module of the camper trailer of FIG. 1 configured in toilet mode;

FIG. 3A is an upper perspective view showing a sanitary module of the camper trailer of FIG. 1 with a closed door; and

FIG. 3B is an upper perspective view showing a sanitary module of the camper trailer of FIG. 1 with an open door.

### DETAILED DESCRIPTION OF PREFERRED EMBODIMENTS

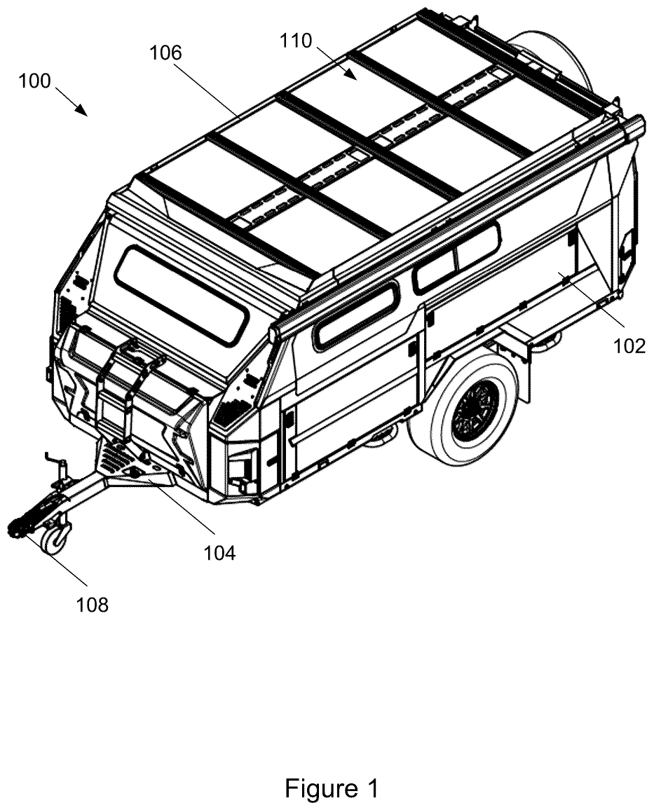

According to an embodiment of the present invention, there is provided a hybrid camper trailer 100 (i.e. towable accommodation) shown in FIG. 1. The camper trailer 100 is to be towed by an automobile such as a four-wheel drive (4WD). The hybrid camper trailer 100 has four hard sides 102 extending up from a frame chassis 104, and a pop-top 106 extending up from the sides 102. The chassis 104 terminates in a tongue coupler 108 for coupling to a tow ball of the 4WD. The camper trailer 100 also includes an undercover sanitary module 110 which will be described in detail below.

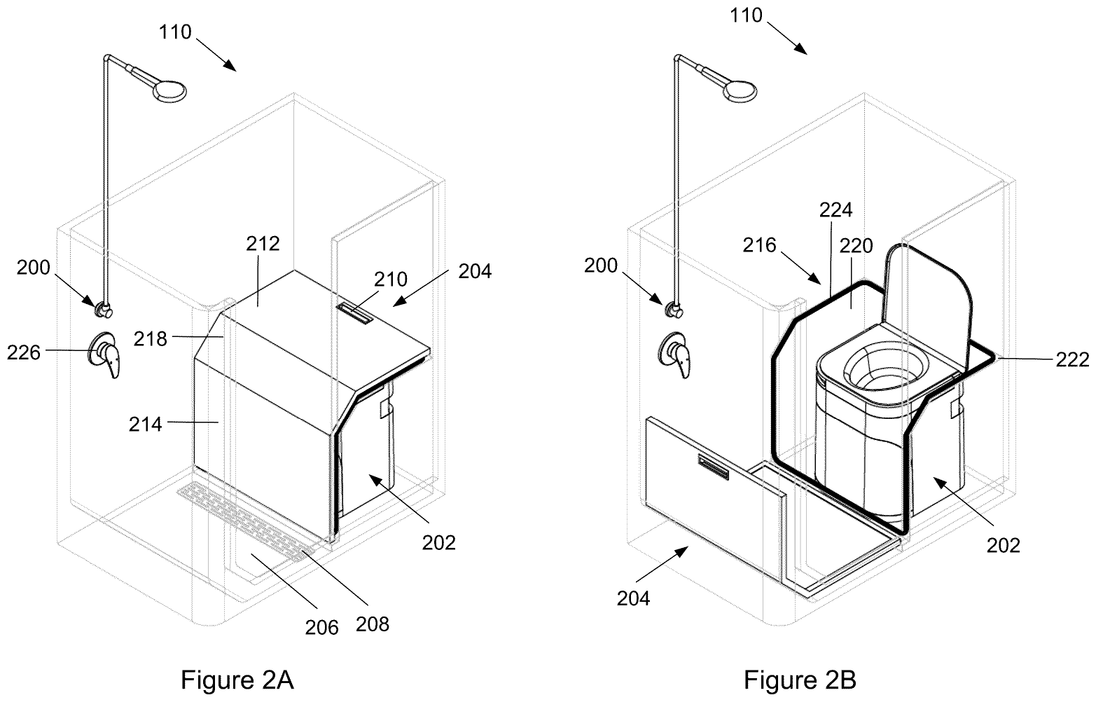

Turning to FIG. 2, the sanitary module 110 includes a shower 200 and a toilet 202. The sanitary module 110 also includes a moveable cover 204 for covering the toilet 202 when using the shower 200 in shower mode (FIG. 2A) to provide for a larger effective showering area. The shower 200 and toilet 202 are located in close proximity, and the bent cover 204 can be used to keep the covered toilet 202 dry from water from the shower 200.

In toilet mode (FIG. 2B), the cover 204 can be moved to alternatively cover a floor 206 of the shower 200 when using the toilet 202. In this manner, the cover 204 provides a walkway that keeps the user's feet dry from any water on the shower floor 206. The cover 204 also covers a drain 208 of the shower 200 in the floor 206.

The cover 204 is hinged relative to the floor 206 and able to freely pivot when moved using a handle 210. The cover 204 is rigid, being made from sheet metal. The cover 204 may instead be molded and integrally formed from hard polymeric material.

Furthermore, the cover 204 includes a roof panel 212 and a perpendicular front wall panel 214 of a toilet receptacle 216 in which the toilet 202 is received. The cover 204 further includes an oblique interconnection panel 218 for interconnecting the roof panel 212 and front wall panel 214. The interconnection panel 218 extends parallel to, and nestles into, an angled mudguard section of the camper trailer 100. Accordingly, the cover 204 forms a complementary fit with the floor 206, a slanted wall and an upright wall of an enclosure of the shower 200.

The toilet receptacle 216 includes a body 220 defining a peripheral lip 222, and the cover 204 which closes the receptacle 216. The toilet receptacle 216 can also include a rubber seal 224, mounted to the lip 222, against which the cover 204 abuts to prevent the ingress of shower water. The shower 200 also includes a mixer tap 226 for controlling the shower water and which is fitted to a shower enclosure.

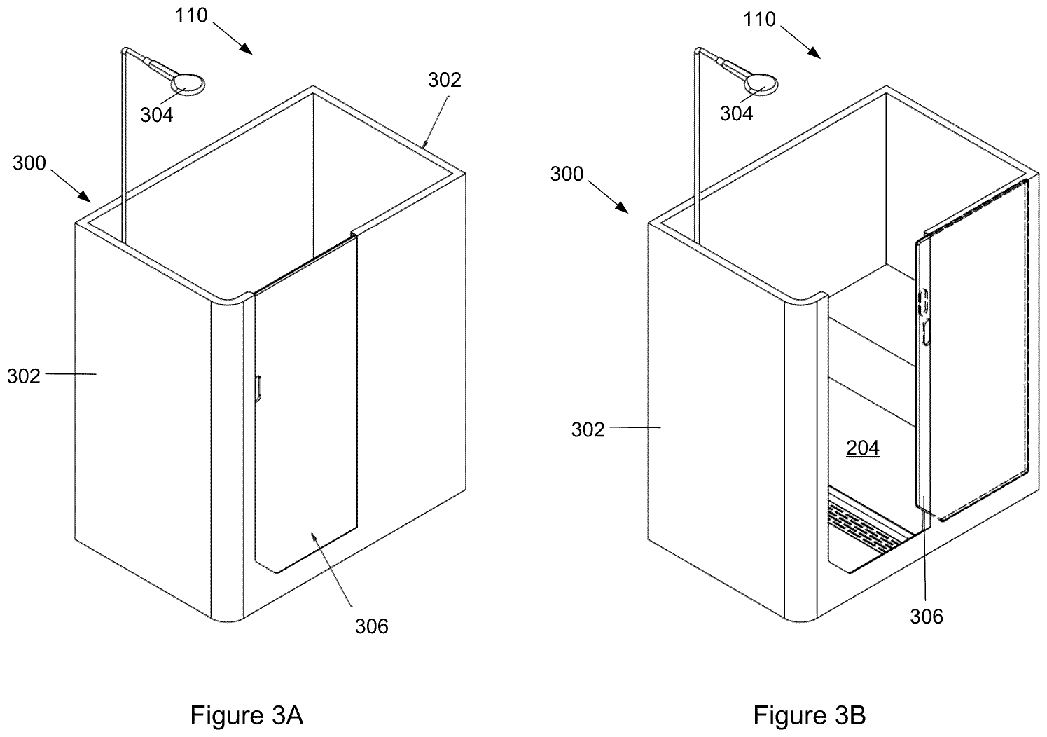

Turning to FIG. 3, the camper trailer 100 includes an outer shower enclosure 300 for containing shower water and which also encloses the toilet 202. The enclosure 300 includes upright walls 302 extending only partially up to a ceiling defined by the expanded pop-top 106. A head 304 of the shower 200 can be attached to the ceiling. Fabric material of the pop-top 106 extending up above the walls 302 can contain any upper spray from the shower 200.

The enclosure 300 also includes a sliding door 306 which can be received within a cavity of the enclosure 300. Alternatively, the door 306 may be hinged.

A person skilled in the art will appreciate that many embodiments and variations can be made without departing from the ambit of the present invention.

For example, in one embodiment, the cover mal be L-shaped with no interconnection panel 218.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A towable accommodation to be towed by an automobile, the towable accommodation including:
a shower;
a toilet; and
a cover for covering the toilet when using the shower.

2. The towable accommodation as claimed in claim 1, wherein the shower and toilet are located in close proximity, and the cover can be used to keep the toilet dry from water from the shower.

3. The towable accommodation as claimed in claim 1, wherein the cover can also cover a floor of the shower when using the toilet to keep the user's feet dry.

4. The towable accommodation as claimed in claim 3, wherein the cover can cover a drain of the shower in the floor.

5. The towable accommodation as claimed in claim 1, wherein the cover can be hinged or able to pivot.

6. The towable accommodation as claimed in claim 1, wherein the cover is bent.

7. The towable accommodation as claimed in claim 1, wherein the cover is rigid, molded, and/or formed from sheet metal or polymeric material.

8. The towable accommodation as claimed in claim 1, wherein the cover forms a complementary fit with a floor and a wall of the shower.

9. The towable accommodation as claimed in claim 1, wherein the cover includes a roof panel and a front wall panel of a toilet receptacle.

10. The towable accommodation as claimed in claim 9, wherein the toilet receptacle includes a body defining a lip.

11. The towable accommodation as claimed in claim 10, wherein the toilet receptacle includes a seal mounted to the lip.

12. The towable accommodation as claimed in claim 9, wherein the cover further includes an interconnection panel for interconnecting the roof panel and front wall panel.

13. The towable accommodation as claimed in claim 12, wherein the roof and front wall panels are perpendicular, and the interconnection panel extends obliquely to the roof and the front wall panels.

14. The towable accommodation as claimed in claim 12, wherein the interconnection panel extends parallel to an angled mudguard section of the accommodation.

15. The towable accommodation as claimed in claim 1, including an enclosure for enclosing the toilet.

16. The towable accommodation as claimed in claim 15, wherein the enclosure contains water from the shower.

17. The towable accommodation as claimed in claim 15, wherein the enclosure includes walls extending only partially up to a ceiling and a head of the shower is attached to the ceiling.

18. The towable accommodation as claimed in claim 15, wherein the enclosure includes a door.

19. The towable accommodation as claimed in claim 18, wherein the door is a sliding door or a hinged door.

20. The towable accommodation as claimed in claim 15, wherein the enclosure is fitted with a tap for controlling the shower.
